(19) United States
(12) Patent Application Publication
(10) Pub. No.: US 2014/0366536 A1
(43) Pub. Date: Dec. 18, 2014

(54) HIGH TEMPERATURE THERMAL ENERGY FOR GRID STORAGE AND CONCENTRATED SOLAR PLANT ENHANCEMENT

(71) Applicant: Abengoa Solar LLC, Lakewood, CO (US)

(72) Inventor: Russell Muren, Lakewood, CO (US)

(21) Appl. No.: 14/356,786

(22) PCT Filed: Nov. 6, 2012
(86) PCT No.: PCT/US2012/063656

§ 371 Date: May 7, 2014

Related U.S. Application Data
(60) Provisional application No. 61/557,292, filed on Nov. 8, 2011.

(51) Int. Cl. F03G 6/00; F24J 2/34

(52) U.S. Cl. CPC F03G 6/00; F24J 2/34
USPC 60/641.8; 165/10; 126/618

(57) ABSTRACT

Disclosed embodiments include grid-tied thermal energy storage (TES) systems, concentrated solar power (CSP) systems featuring grid-tied TES and methods of operating same. Grid-tied TES systems include a heat storage material, a heat transfer material in thermal communication with a source of concentrated solar flux and an electric heating element. Both the heat transfer material and the electric heating element are in thermal communication with the heat storage material. Both the heat transfer material and the electric heating element can be selectively used to provide alternate and complimentary means to store thermal energy in the heat storage material.

### RELATED APPLICATIONS

The instant application claims the benefit of U.S. Provisional Patent Application No. 61/557,292, filed Nov. 8, 2011, which application is incorporated herein by reference in its entirety.

### TECHNICAL FIELD

The embodiments disclosed herein relate to concentrated solar power electricity generation. In particular, disclosed embodiments relate to thermal energy storage in a grid-connected CSP generation plant.

### BACKGROUND

Concentrating Solar Power (CSP) systems utilize solar energy to drive a thermal power cycle for the generation of electricity. CSP technologies include parabolic trough, linear Fresnel, central receiver or “power tower,” and dish/engine systems. Considerable interest in CSP has been driven by renewable energy portfolio standards applicable to energy providers in the southwestern United States and renewable energy feed-in tariffs in Spain. CSP systems are typically deployed as large, centralized power plants to take advantage of economies of scale.

Much recent work has been directed at improving the overall efficiency, cost and grid-compatibility of CSP generation, in order to compete more effectively with non-renewable energy generation sources. For example, it is known that an overall increase in conversion efficiency can be obtained with a combined or hybrid CSP and fossil fuel generation plant. See for example, U.S. Pat. Nos. 7,845,172 and 7,331,178. The incorporation of a fossil energy source in a hybrid CSP plant can further enhance the dispatchability of the plant by allowing the generated output to be adjusted more easily to the varying needs of utilities. However, large scale gas-booster-CSP technology faces a number of challenges, including natural gas supply cost volatility, relatively complicated gas burner technology and regulatory schemes that offer incentives for eliminating greenhouse gas emissions entirely.

A key advantage of certain CSP systems, in particular parabolic troughs and power towers, is the ability to incorporate thermal energy storage (TES) where thermal energy is stored to and withdrawn from a suitable heat storage medium. TES is often less expensive and more efficient than conventional electric energy storage such as batteries. In addition, the use of TES allows a CSP plant to have an increased capacity factor and provide the ability to dispatch power to a grid operator as needed, to cover afternoon/evening or other high energy demand peaks for example.

Large-scale TES can mitigate the natural variability of renewable energy sources, including CSP plants, and lead to increased stability of a utility grid featuring a substantial contribution from renewable sources. Conventional TES systems face a range of technical and market barriers however. For example, TES systems featuring a chemical storage medium generally offer an insufficient number of cycles and low storage density, while other TES technologies such as compressed air can be applied in only a limited number of geographic locations.

Certain known TES systems feature the use of phase change materials as a thermal energy storage medium. One benefit of utilizing a phase change material as the thermal energy storage medium of a TES system is the high energy density realized by exploiting the latent heat as well as the sensible heat of a suitable phase changing TES material. Therefore, largely because of this inherently large heat capacity, TES systems based on phase change materials are of increasing interest for application in CSP plants.

Fossil fuel boosting in a hybrid CSP plant is known to increase the efficiency of CSP generation but fossil fuel boosting typically cannot help balance the generation and load in a grid that relies on renewable sources. For example, fossil fuel boosting systems cannot assure that generation capacity does not exceed the load during very windy or very sunny periods when the grid includes wind or solar powered generation. While TES can also increase the dispatchability of CSP generation, it also typically cannot increase the load and generation balance of a grid. Large, utility-scale thermal storage plants could balance a grid but known storage technologies decrease efficiency and add cost. What is needed, therefore, is a means to increase the dispatchability and efficiency of CSP generation, while increasing CSP power cycle performance and offering large-scale energy storage for balancing the load and generation of a grid relying on renewable resources. The embodiments disclosed herein are directed toward overcoming one or more of the problems discussed above.

### SUMMARY OF THE EMBODIMENTS

One embodiment disclosed herein is a grid-tied thermal energy storage (TES) system. The grid-tied TES system includes a heat storage material, a heat transfer material in thermal communication with a source of concentrated solar flux and an electric heating element. Both the heat transfer material and the electric heating element are in thermal communication with the heat storage material. Both the heat transfer material and the electric heating element provide alternate and complimentary means to store thermal energy in the heat storage material. In particular, the heat storage material may be selectively heated by heat exchange with the heat transfer material and/or by applying electric power to the electric heating element.

The heat transfer material may be a working fluid in thermal communication with a power cycle or a heat transfer fluid (HTF) in thermal communication with the working fluid. The heat storage material may be any suitable material in any phase. Certain heat storage materials are phase change materials which will undergo a phase change when the heat storage material is heated to an operational temperature. For example, the heat storage material can be a salt and the electric heating element would then be implemented with a resistive heater in thermal contact with the salt. In another representative example, the heat storage material may be a metal and the electric heating element could them be implemented with an induction heater.

An alternative embodiment disclosed herein is a concentrated solar power (CSP) system having a solar receiver configured to heat a heat transfer material with concentrated solar flux. The disclosed CSP systems also feature a grid-tied TES system as disclosed above and a power cycle in thermal communication with the heat transfer material providing for the generation of electrical power. The grid-tied TES system of the disclosed CSP embodiments may be charged with thermal energy from either or both of the heat transfer material after it has been heated by concentrated solar flux or the electric heating elements.

In all grid-tied TES or CSP embodiments, supplemental heat energy may be provided to the heat storage material from the electric heater element when the TES system is in a charging mode or when the TES system is otherwise discharging. As used herein, the TES system is being charged when it is being heated by the working fluid or HTF. The TES system is generally in a discharge mode when the TES system is being used to heat the working fluid or HTF.

For example, during the day when the grid-tied TES system is typically being charged by solar flux, supplemental electrically generated heat may be used to enhance the performance of the CSP plant by heating the HTF to a higher temperature than is otherwise possible using solar energy alone. Alternatively, additional heat transferred to the heat storage material through electric heating means can extend the operational hours of a CSP plant at night or during periods of low solar flux when the TES system is typically being discharged. Accordingly, a CSP plant featuring a grid-tied TES system will have enhanced dispatchability, generally higher efficiency and enhanced grid compatibility.

In certain embodiments, the grid-tied TES systems can be scaled and implemented with apparatus having much greater thermal capacity than required to merely enhance local CSP efficiency and dispatchability. A large scale TES system may therefore also offer utility-scale energy storage such that surplus energy generated anywhere on the grid at periods of low demand or periods of high production can be utilized by the CSP plant during periods of high demand, thereby balancing the entire grid.

Alternative embodiments include methods of storing thermal energy and generating power using a CSP featuring grid-tied TES as described above.

### BRIEF DESCRIPTION OF THE DRAWINGS

FIG. 1 is a schematic diagram of a grid-tied TES system in a CSP plant.

FIG. 2 is a schematic diagram of a grid-tied TES system in an alternative CSP plant.

FIG. 3 is a perspective view of a heat exchanger module.

FIG. 4 is a top perspective view of a TES tank containing multiple heat exchanger modules.

FIG. 5 is a schematic diagram showing one configurations of a tank, heater and heat exchange modules featuring inductive heaters.

FIG. 6 is a schematic diagram showing one configurations of a tank, heater and heat exchange modules featuring resistive heaters.

FIG. 7 is a schematic diagram showing one configurations of a tank, heater and heat exchange modules featuring alternative resistive heaters.

FIG. 8 is a flow chart diagram of a method as disclosed herein.

### DETAILED DESCRIPTION

Unless otherwise indicated, all numbers expressing quantities of ingredients, dimensions, reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

All the features described in this specification (including the claims, description and drawings) and/or all the steps of the described method can be combined in any combination, with the exception of combinations of such mutually exclusive features and/or steps.

Various embodiments of grid-tied thermal energy storage (TES) systems and concentrated solar power (CSP) plants are disclosed herein. As described in detail below, the disclosed TES and CSP systems may be thermally charged by solar flux and the TES systems may also be thermally charged using electrical energy from the utility grid. The grid-tied TES systems described herein may thus accomplish multiple goals, including but not limited to; provide large scale energy storage to the electrical grid, increasing the efficiency of electrical energy generation using CSP and increasing the dispatchability of a CSP plant.

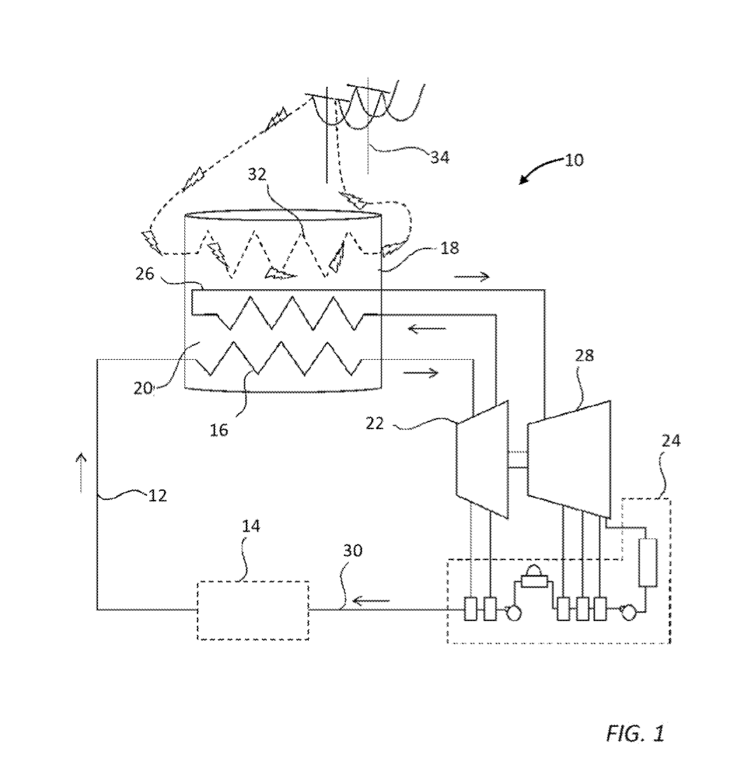

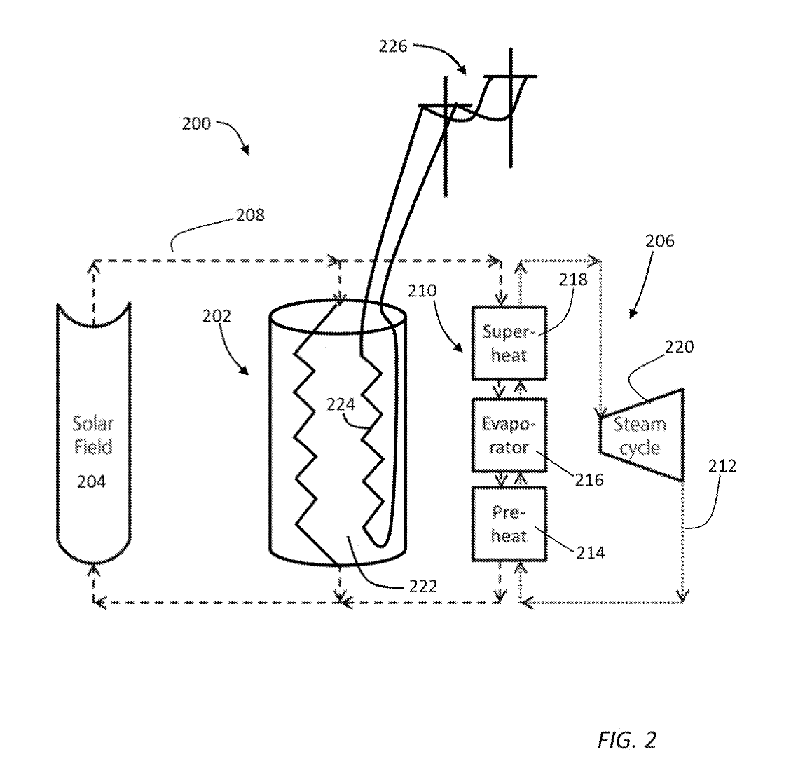

CSP plants typically utilize a power cycle having turbine driven power generation elements. Power to the turbines is provided by a working fluid which is directly or indirectly heated to operational temperatures by solar energy. Some CSP plants utilize a heat transfer fluid (HTF) circuit where the HTF is directly heated to operational temperatures by solar energy and a separate power cycle working fluid is thermally charged by heat exchange with the HTF. The grid-tied TES embodiments disclosed herein may be implemented in a system utilizing separate HTF materials or in a system where the power cycle working fluid is directly heated by solar energy. For example, FIG. 1 shows one possible CSP system utilizing one embodiment of the disclosed grid-tied TES where the working fluid is directly heated by solar energy. FIG. 2 shows an alternative CSP system featuring grid-tied TES; the FIG. 2 embodiment utilizes a separate HTF circuit however.

The power cycle working fluid and any separate HTF are referred to herein collectively as “heat transfer materials.” Heat transfer materials may be present in gaseous, liquid or solid phases. The defining characteristic of a heat transfer material is that it can be heated by solar flux and also a heat transfer material can directly or indirectly provide thermal energy to drive electrical energy generation.

In any type of CSP system, the working fluid is defined as the fluid which directly drives the power generation elements. The working fluid may be, but is not limited to, steam, used for example in a Rankine power cycle, or carbon dioxide used, for example, in a supercritical Brayton cycle. In systems which utilize a separate but thermally coupled HTF circuit, the HTF may be implemented with a wide range of materials including but not limited to traditional heat transfer oils, various materials that undergo a liquid-gas or solid-liquid phase change at operational temperatures, solids such as certain metals, falling particles, salts and other materials. The grid-tied TES embodiments described herein might be optimized for certain working fluids and HTFs. It is important to note however that the grid-tied TES embodiments are not limited to any one or more working fluids, HTFs, CSP or power cycle architectures. On the contrary, the disclosed grid-tied TES embodiments may be implemented advantageously with any CSP architecture or mixed CSP architectures.

In one embodiment, the grid-tied TES system includes at least one, but typically several, heat exchanger modules embedded in a heat storage medium which may in certain implementations be a phase change material (“PCM”) held in a tank. The heat storage medium may be heated and the storage system thermally charged, by passing heated working fluid or heated HTF through one or more heat exchanger modules in thermal communication with the heat storage medium. If the heat storage medium is a PCM, the storage medium may be heated and/or caused to undergo a phase change by thermal interaction with heated working fluid or HTF. The grid-tied TES systems disclosed herein may also be thermally charged with electrical energy obtained from the utility grid. Electric charging of the grid-tied TES systems occurs by way of a heat delivery means thermally coupled to the heat storage medium. The heat delivery means may be electrical resistance heaters embedded in the heat storage medium or induction heaters surrounding a tank of electrically conductive heat storage medium.

When a grid-tied TES system is charged by contact with a solar-heated material, by electric heating or both, the system may be discharged when working fluid or HTF of lower temperature is selectively passed through the TES system to increase the subject fluid temperature. Properly timed discharge from a TES can enhance overall power cycle efficiency, improve CSP dispatchability and with respect to the grid-tied TES embodiments disclosed herein, balance the generation and load on the electric power grid.

FIG. 1 shows one representative CSP architecture 10 in which a Rankine cycle working fluid, steam, enters conduit 12 after being produced by concentrated solar flux at a solar receiver 14 of a concentrated solar power plant. In this and all other embodiments, including those that do not involve a Rankine cycle, the solar receiver 14 may be adapted in different ways to provide heat to the working fluid, including, as detailed below with respect to FIG. 2, by delivery of heat to a heat transfer fluid that in turn transfers heat to the working fluid via a heat exchanger. In the embodiment shown in FIG. 1, the steam, once generated, travels through a superheater heat exchanger 16 inside a grid-tied TES system 18 filled with a heat storage material which may be a high temperature phase change material 20. The steam is then routed to drive a high pressure steam turbine 22. Some steam may also be bled off into a feedwater heater system 24, with the remaining steam flowing through the reheat portion 26 of the grid-tied TES system 18 and back to a low pressure steam turbine 28 to drive additional power generation. The steam exiting the turbine 28 then flows into a condenser and feedwater heaters 24 and, in liquid form, back through conduit 30 to the CSP plant receiver 14 to be reheated by concentrated solar flux to produce steam.

The grid-tied TES system 18 also includes an electrical heating element 32 to selectively provide additional or supplemental heat to the heat storage material in the grid-tied TES system 18. The interconnection of the electrical heating element 32 with the grid 34 is shown schematically in FIG. 1. The electrical heating element 32 may be implemented with resistive heating elements or inductive heating elements, depending upon the nature of the heat storage material.

In the FIG. 1 embodiment the grid-tied TES system 18 is implemented with a PCM storage module placed after the solar receiver/steam generator 14 in the steam line of a solar fired Rankine power cycle. In other embodiments the grid-tied TES system may be positioned elsewhere, for example, on the line between multiple turbine stages.

Although the grid-tied TES systems disclosed herein are not limited to systems using a PCM heat storage material, one benefit of a PCM system is simplicity and low cost at temperatures above 400° C. At such high target operating temperatures, metallic storage materials may be the most appropriate, though salt and other materials may also be considered. Large cylindrical metal tanks, possibly lined with a suitable inert material, may be economic storage vessels for a PCM heat storage material having many heat exchanger elements, for example, either plates or coils, immersed in the PCM.

Grid-tied TES is applicable to both new and existing plants. Existing plants may be retrofitted by interconnecting the grid-tied TES system between steam generator and steam turbine, and between multiple turbine stages, as appropriate. By tailoring the mass of heat storage material to achieve optimum balance between the thermal output of a given solar field and the requirements the associated power cycle, a grid-tied TES system may be designed to accommodate the needs of any size of new or existing plant.

Each of the embodiments of grid-tied TES disclosed herein, having one or more types of electrical heating system connected to the electric grid, allows power to be taken from the grid to heat a heat transfer material associated with the storage system. During the day, the electrically generated heat may be used to enhance the performance of the CSP plant by heating the power cycle working fluid or a HTF to a higher temperature than is otherwise possible using solar energy alone. Alternatively, the additional heat transferred to the heat storage material through electric heating means can extend the operational hours of a CSP plant at night or during periods of low solar flux. Accordingly, a CSP plant featuring a grid-tied TES system will have enhanced dispatchability, generally higher efficiency and grid compatibility. Grid-tied TES systems also offer utility-scale energy storage such that surplus energy generated at periods of low demand or high generation output can be utilized during periods of high demand thereby balancing the entire grid.

FIG. 2 shows an alternative solar power generation system 200 featuring the use of a grid-tied TES system 202. The CSP system 200 may be considered to have multiple functional blocks including; one or more solar energy concentrators or receivers 204, one or more grid-tied TES systems 202 and one or more power blocks 206. The solar energy concentrator elements 204 may be of any known type, including but not limited to, parabolic trough reflectors, heliostat based solar energy towers or similar apparatus. In all cases the solar concentrator element 204 concentrates reflected sunlight upon the surface of a tube or other receiver structure within which HTF is circulated. The HTF is thus heated by the concentrated sunlight and used to generate electric power as described below. A commercially implemented solar power generation system 200 will generally have many parabolic trough type solar energy concentrators 204 in a solar field or a lesser number of tower and receiver type solar energy concentrators 204 for each grid-tied TES system 202 or power block 206.

In the FIG. 2 embodiment, the solar energy concentrator 204, grid-tied TES system 202 and power block 206 are each maintained in thermal communication through a HTF circuit 208. The HTF circuit 208 has heat transfer fluid (which may be in a gaseous, liquid or solid phase, depending upon the HTF material selected) flowing or transported within pipes, conduits, valves, pumps and other structures of the circuit 208.

The power block 206 includes various steam train components 210 which provide for heat exchange between HTF flowing in the HTF circuit 208 and water or another working fluid flowing in a working fluid circuit 212. Typically, the power block 206 includes at least the following steam train components; a pre-heater 214, an evaporator 216 and a super-heater 218, arranged in order from lesser to greater operational temperature. In the various steam train components 210, heat is exchanged between the HTF circuit 208 and the working fluid circuit 212 resulting in the production of super heated steam which may be used to drive one or more steam turbines 220 for power generation. While the grid-tied TES system 202 is shown in FIG. 2 as an element of the HTF circuit 208, it is important to note that a grid-tied TES system may alternatively or additionally be associated with the working fluid circuit 212 and steam train components 210.

The grid-tied TES system 202 may include many individual containers with each containing a heat storage material 222, which may be a phase change material having a selected melting temperature. During certain periods of operation, heated HTF flowing or transported from the solar energy concentrator 204 is in part flowed through the grid-tied TES system 202 thereby heating the heat storage material 222 and possibly melting and heating the heat storage material if it is a PCM. In addition, the heat storage material may also be selectively heated by an electric heating element 224, receiving power from the utility grid 226.

The solar power generation system 200 may be operated in two modes with respect to the thermal energy storage system 202; charge mode and discharge mode. Operation in the charge mode is schematically represented in FIG. 2. In the charge mode, incident solar radiation falling upon a solar energy concentrator 204 is concentrated by reflection to heat a portion of the HTF circuit 208 flowing through or near the concentrator. Upon exit from the solar energy concentrator 204, the heated heat transfer fluid is routed to the power block 206 and/or the grid-tied TES system 202 to heat the heat storage material 222. In a discharge mode, thermal energy is transferred to the HTF from heated heat storage material 222.

Supplemental heat energy may be provided to the heat storage material 222 from the electric heater element 224 in either the charging mode or the discharging mode. For example, during the day when the grid-tied TES system is typically charged by solar flux, supplemental electrically generated heat may be used to enhance the performance of the CSP plant by heating the HTF to a higher temperature than is otherwise possible using solar energy alone. Alternatively, the additional heat transferred to the heat storage material through electric heating means can extend the operational hours of a CSP plant at night or during periods of low solar flux when the TES system is typically being discharged. Accordingly, a CSP plant featuring a grid-tied TES system will have enhanced dispatchability, generally higher efficiency and grid compatibility.

In certain embodiments, the Grid-tied TES systems 202 can be scaled and implemented with apparatus having much greater thermal capacity than required to merely enhance local CSP efficiency and dispatchability. A large scale TES system may therefore also offer utility-scale energy storage such that surplus energy generated anywhere on the grid at periods of low demand or periods of high generation output can be utilized during periods of high demand thereby balancing the entire grid.

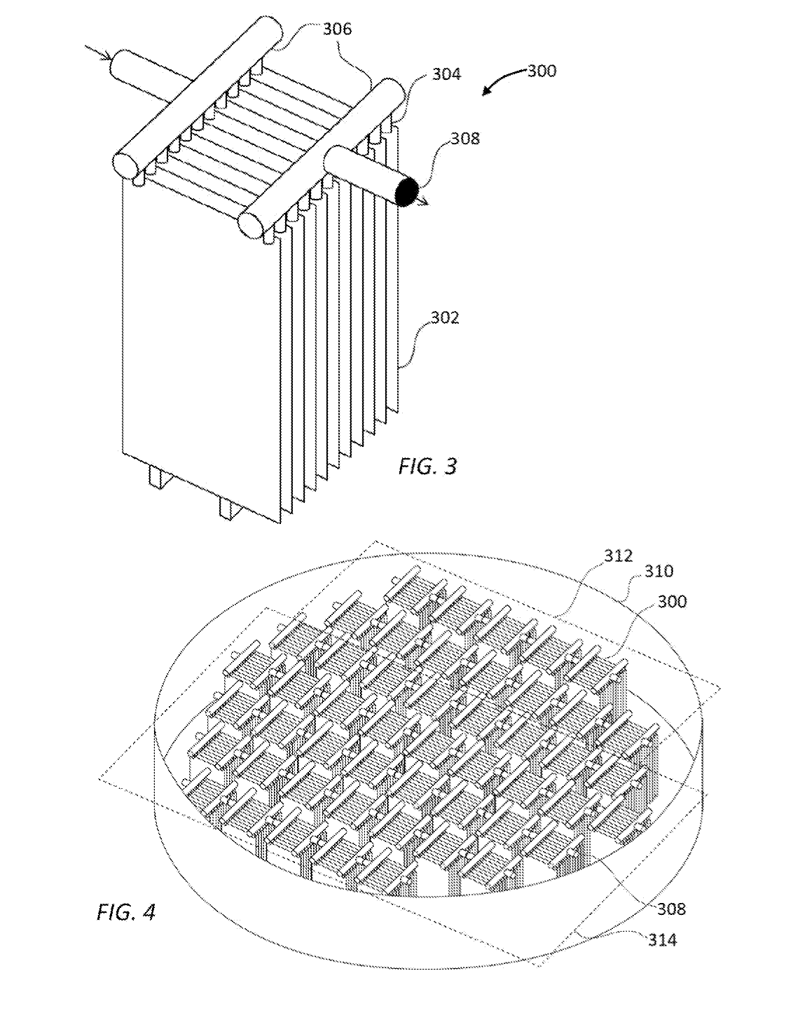

FIG. 3 shows one representative, but non-limiting single heat exchanger module 300 comprising multiple heat exchanger plates 302 for transferring heat to or from working fluid or HTF to a heat storage material as described above. Each plate has inlet and outlet ports 304 connected to a module header system 306 that allows working fluid to flow in parallel through the multiple plates, and an overall storage system header 308 for connecting the flow of working fluid between multiple modules.

FIG. 4 shows a grid-tied TES system embodiment having the multiple heat exchanger modules 300 integrated into a tank 310. In the FIG. 4 embodiment, the array of heat exchanger modules 300 are connected by a header system 308 and separated into reheat 312 and superheat 314 zones. The reheat 312 and superheat 314 zones are useful when working fluid is passing from multiple points in a power cycle through the grid tied TES system. For example, as shown in FIG. 1 working fluid may be passed through the grid-tied TES system from a point between the solar receiver/steam generator and turbine and a point between the first and second turbine stages.

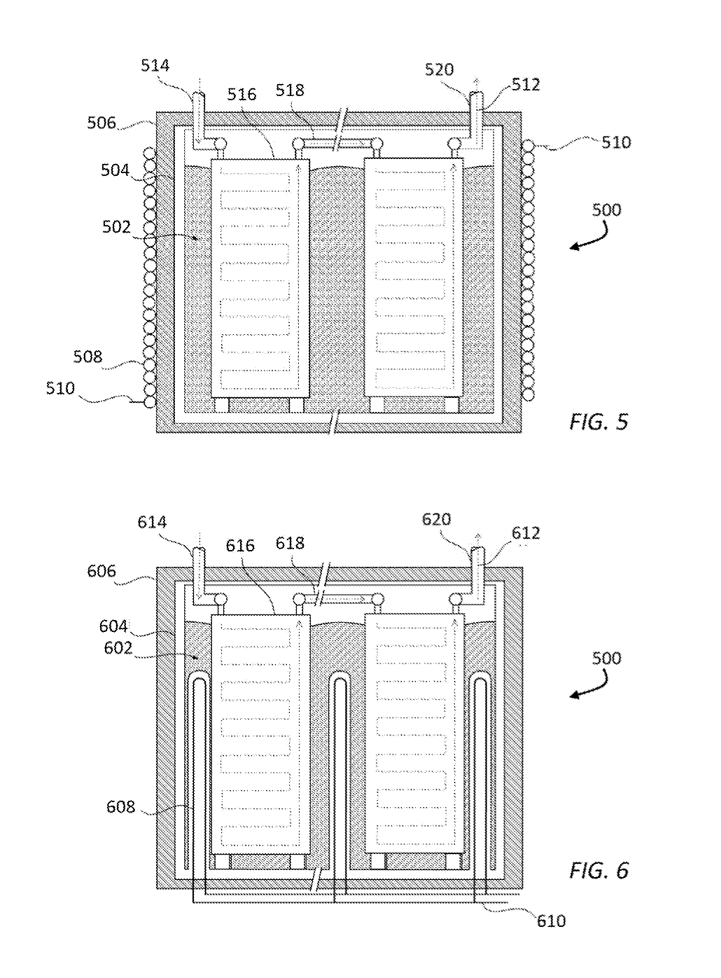

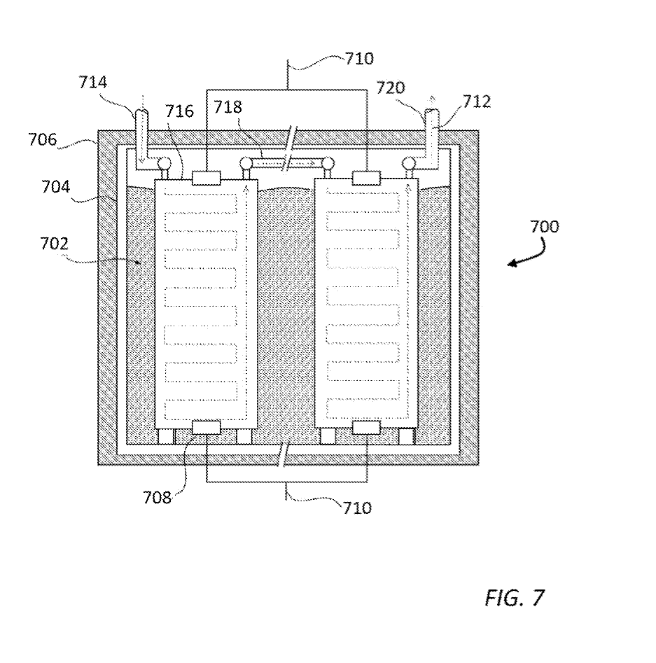

There are multiple possible embodiments of heating and melting systems which may be employed in a grid-tied TES unit using a PCM material as the heat storage material. In general, the heating/melting strategy implemented will depend on the heat storage material selected. For example, a metallic PCM, such as aluminum, will be amenable to heating by induction heating coils, as shown in FIG. 5, while a salt, such as magnesium chloride, will require the direct heating methods of FIGS. 6 and 7 as described below. FIG. 5 shows a grid-tied TES system embodiment 500 in which a PCM 502 may be held in a tank 504 that is surrounded by insulation 506. Heat may be added to the PCM 502 by means of induction coils 508 that surround the tank and are connected to an electric circuit 510 drawing power from the grid. Heat may be extracted from the PCM by (for example) steam working fluid 512 flowing into the system at an inlet 514, through a set of repeating heat exchanger modules 516 that are duplicated and interconnected to match the requirements of the system, through a header system 518 to any other heat exchangers and then flowing out of the system through an exit port 520.

FIG. 6 shows an alternative grid-tied TES system 600 in which PCM 602 is held in a tank 604 surrounded by insulation 606. Heat may be added to the PCM by means of resistive heat trace coils 608 that are immersed in the tank and are connected to an electric circuit 610 drawing power from the grid. Heat may be extracted from the PCM by (for example) a power cycle working fluid 612 flowing into the system at an inlet 614 through a heat exchanger 616, through a header system 618 to other heat exchangers and then flowing out of the system through an exit port 620.

FIG. 7 shows an alternative embodiment of grid-tied TES system 700 in which PCM 702 is held in a tank 704 surrounded by insulation 706. Heat may be added to the PCM by means of impedance heating applied through the heat exchanger surface which is electrically interconnected at electrical connection 708 to an electric circuit 710 drawing power from the grid. Heat may be extracted from the PCM by (for example) a power cycle working fluid 712 flowing into the system at an inlet 714 through a heat exchanger 716, through a header system 718 to other heat exchangers and then flowing out of the system through an exit port 720.

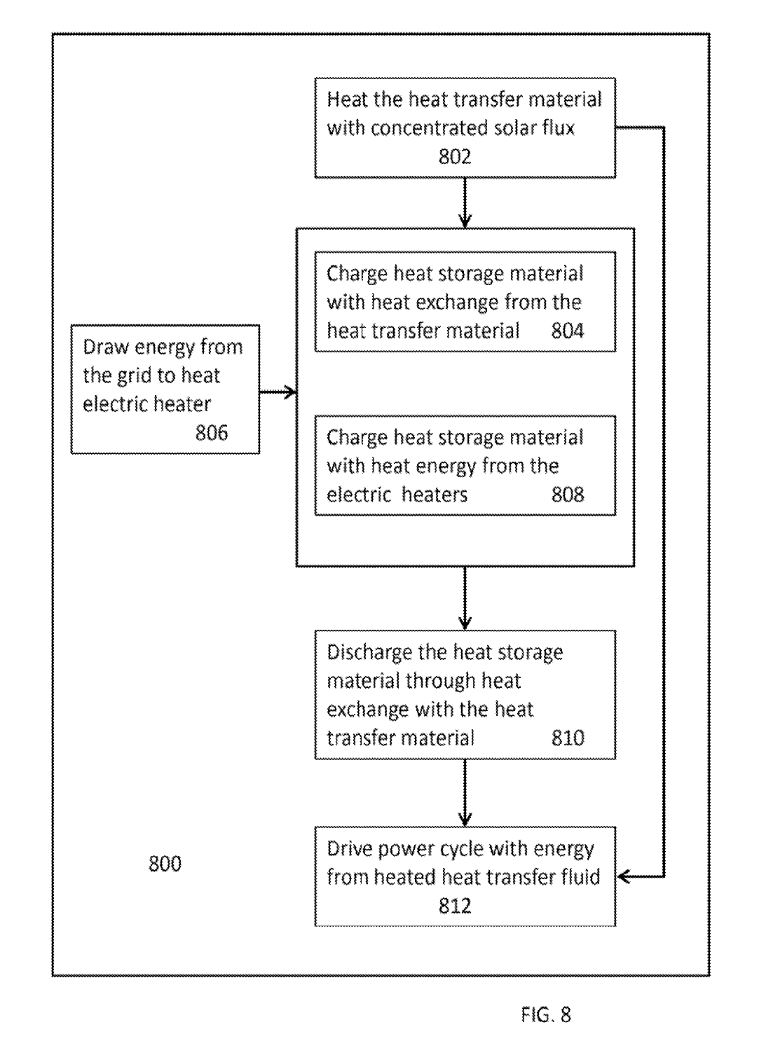

Alternative embodiments disclosed herein include methods of generating electrical energy using CSP having one or more of the grid-tied TES systems as described above. As shown in FIG. 8, one method embodiment 800 includes the step of heating a heat transfer material with concentrated solar flux (Step 802). As noted above, the heat transfer material may be the working fluid of a power cycle or the heat transfer material may be a separate HTF used to transfer thermal energy to the working fluid of the power cycle. In addition, the heat transfer material may be in a gas, solid or liquid phase during use, or may change phases at operational temperatures. In certain embodiments the heat transfer material and the working fluid are the same material.

The method further includes heating a heat storage material through heat exchange with the heat transfer material (step 804). Heat exchange between the heat transfer material and heat storage material may occur in any of the grid-tied TES systems described herein or in similar systems featuring heat exchangers. The heat storage material may, in certain embodiments be a phase change material which changes phases from, for example, solid to liquid phase when the heat storage material is heated to an operational temperature sufficient to support power generation. In all embodiments, the heat storage material may also be heated with an electric heating element (steps 806, 808). Certain heat storage materials, such as salt-based PCM are best suited to use in grid-tied TES systems using a resistive electric heating element. Other heat storage materials, such as metals, can be used in grid-tied TES systems having inductive heating elements.

The method further includes providing energy to the working fluid of a power generation cycle by heat exchange between the working fluid and the heat storage material (steps 810 and 812). Steps 804 and 808 both involve transferring thermal energy to the heat storage material and are referred to as charging the heat storage material or charging the TES system. On the contrary, step 810 concerns discharge of the TES system where energy is provided from the TES system directly or indirectly to the working fluid of the power cycle. Typically, charging through heat exchange between the heat storage material and the heat transfer material (step 804) occurs during the day and in particular during periods of high solar flux. Charging of the grid-tied TES system using an electric heating element can occur at any time however. In addition, the electric heating element can be used to heat the heat storage material to a higher temperature than is possible by charging through heat exchange with the heat transfer material alone. Thus, the disclosed grid-tied TES systems and CSP systems can produce power during periods of reduced solar flux and have enhanced dispatchability.

The electrical energy provided to the electric heating elements of a grid-tied TES system can be generated at any power plant of any type connected to the utility grid. Accordingly, surplus energy generated at times of low demand by any power plant connected to the grid can be stored as thermal energy in the grid-tied TES systems disclosed herein.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the embodiments disclosed herein have been particularly shown and described with reference to a number of alternatives, it would be understood by those skilled in the art that changes in the form and details may be made to the various configurations disclosed herein without departing from the spirit and scope of the disclosure. The various embodiments disclosed herein are not intended to act as limitations on the scope of the claims. All references cited herein are incorporated in their entirety by reference.

What is claimed is:

1. A grid-tied thermal energy storage system comprising:
a heat storage material;
a heat transfer material in thermal communication with a source of concentrated solar flux and further in thermal communication with the heat storage material providing for the heat storage material to be selectively heated or cooled through heat exchange with the heat transfer material; and
an electric heating element in thermal communication with the heat storage material providing for the heat storage material to be selectively heated by applying electric power to the electric heating element.

2. The grid-tied thermal energy storage system of claim 1 wherein the heat transfer material comprises at least one of a working fluid in thermal communication with a power cycle or a heat transfer fluid in thermal communication with the working fluid.

3. The grid-tied thermal energy storage system of claim 1 wherein the heat storage material is a phase change material which will undergo a phase change when the heat storage material is heated to an operational temperature.

4. The grid-tied thermal energy storage system of claim 2 wherein the heat storage material comprises a salt and the electric heating element comprises a resistive heater.

5. The grid-tied thermal energy storage system of claim 2 wherein the heat storage material comprises a metal and the electric heating element comprises an induction heater.

6. A concentrated solar power system comprising:
a solar receiver configured to heat a heat transfer material with concentrated solar flux;
a grid-tied thermal energy storage system comprising a heat storage material in thermal communication with the heat transfer material and an electric heating element in thermal communication with the heat storage material, whereby the heat storage material can be heated through heat exchange with the heat transfer material or through heating provided by the electric heating element; and
a power cycle in thermal communication with the heat transfer material providing for the generation of electrical power.

7. The concentrated solar power system of claim 6 wherein the heat transfer material comprises at least one of a working fluid in thermal communication with a power cycle or a heat transfer fluid in thermal communication with the working fluid.

8. The concentrated solar power system of claim 6 wherein the heat storage material is a phase change material which will undergo a phase change when the heat storage material is heated to an operational temperature.

9. The concentrated solar power system of claim 6 wherein the heat storage material comprises a salt and the electric heating element comprises a resistive heater.

10. The concentrated solar power system of claim 6 wherein the heat storage material comprises a metal and the electric heating element comprises an inductive heater.

11. The concentrated solar power system of claim 6 wherein the power cycle comprises a high pressure turbine stage and a low pressure turbine stage and wherein the grid-tied thermal energy storage system provides for heat exchange with a power cycle working fluid before the high pressure turbine stage and before the low pressure turbine stage.

12. The concentrated solar power system of claim 6 wherein the grid-tied thermal energy storage system provides for the thermal storage of electrical energy generated at a location remote from the solar receiver.

13. A method for operating a concentrated solar power plant comprising:
heating a heat transfer material with concentrated solar flux;
heating a heat storage material through heat exchange with the heat transfer material;
heating the heat storage material with an electric heating element; and
providing energy to a working fluid of a power generation cycle by heat exchange between the working fluid and the heat storage material.

14. The method of claim 13 wherein the heat transfer material and the working fluid are the same material.

15. The method of claim 13 wherein the heat transfer material comprises a heat transfer fluid in thermal communication with the working fluid.

16. The method of claim 13 further comprising:
heating the heat storage material to a first operational temperature through heat exchange with the heat transfer material; and
heating the heat storage material to a second operational temperature greater than the first operational temperature with the electric heating element.

17. The method of claim 17 further comprising heating the heat transfer material to the second operational temperature through heat exchange with the heat storage material.

18. The method of claim 13 wherein the heat storage material comprises a salt and the electric heating element comprises a resistive heater.

19. The method of claim 13 wherein the heat storage material comprises a metal and the electric heating element comprises an induction heater.

20. The method of claim 13 further comprising providing for the thermal storage of electrical energy generated at a location remote from the solar receiver by heating the heat storage material with the electric heating element.
